(19) United States
(12) Patent Application Publication
(10) Pub. No.: US 2008/0261576 A1
(43) Pub. Date: Oct. 23, 2008

(54) Communication system for oil and gas platforms

(75) Inventor: Michael S. Wengrovitz, Concord, MA (US)

Correspondence Address: GARLICK, HARRISON & MARKISON (ALU), P.O. BOX 160727, AUSTIN, TX, 78716-0727, US

(73) Assignee: ALCATEL LUCENT, Paris (FR)

(21) Appl. No.: 12/105,341

(22) Filed: Apr. 18, 2008

Related U.S. Application Data
(60) Provisional application No. 60/913,080, filed on Apr. 20, 2007.

(51) Int. Cl. H04M 3/42

(52) U.S. Cl. 455/416

(57) ABSTRACT

Communications between oil platform operators and radio users on oil platforms are facilitated using a conference server that provides software-based conference rooms enabling the oil platform operators to speak and listen to desired radio users and other oil platform operators.

### CROSS-REFERENCE TO RELATED APPLICATIONS

This U.S. Nonprovisional application for patent claims the benefit of the filing date of U.S. Provisional Patent Application entitled, COMMUNICATION SYSTEM FOR OIL AND GAS PLATFORMS, Attorney Docket No. 801474P, having Ser. No. 60/913,080, filed on Apr. 20, 2007, which is incorporated herein by reference for all purposes.

### BACKGROUND OF THE INVENTION

1. Technical Field of the Invention

The present invention relates in general to communications systems, and in particular, to conferencing systems.

2. Description of Related Art

Oil and gas platforms are among the world's largest physical structures. Radio-telephone systems on these platforms facilitate voice communications between workers having radios tuned to specific frequency channels and operators having telephones. Operators issue instructions and provide important information to the workers, and the associated voice communication must be efficient and highly-reliable.

Workers, also referred to herein as users, tuned to the same radio channel hear the same audio. When a user on a certain channel depresses his radio's push-to-talk button, all other users on this same channel hear the user speaking. One or more operators who are assigned to listen to this channel will also hear the user speaking. However, an operator can listen to multiple channels simultaneously, while a user can listen and talk only on a single assigned channel. Each operator typically talks to a single preassigned channel, but under some circumstances, an operator may talk to a group of channels at the same time.

In a typical usage scenario, a first operator might speak to a single radio channel inquiring about the pressure setting on a certain valve or sensor. One of the users assigned to this channel might speak through his radio's headset indicating that he is currently nearby the location of the sensor and that he will report back soon. Shortly thereafter, this user observes the sensor and reports back the requested measurement by speaking into his radio. The first operator thanks the user, while a second operator, who also hears this measurement report, issues a second directive to the users on his channel to make an appropriate drilling adjustment.

Existing oil platform radio-telephone conferencing systems require operators to use buttons and displays on their telephone sets. However, telephone sets having a limited number of push buttons and small displays can be awkward and inconvenient for operators to use. Also, existing oil platform radio-telephone conferencing systems typically require special-purpose hardware cards, DSP boards and special cabinets and chasses that can be difficult to replace or repair.

Therefore, what is needed is a communication system that improves the user interface, provides more communication flexibility and reduces the hardware support elements needed for a conferencing system on oil platforms.

### SUMMARY OF THE INVENTION

A conference server, in one embodiment of the present invention, facilitates communication on oil platforms using a client-server software-based approach. The conference server includes a software-enabled conference room operable to manage a conference call between oil platform operators and radio channels, in which each of the radio channels has a respective group of radio users communicating with each other thereon. The conference server further includes an application program interface that receives conferencing instructions from one or more of the oil platform operators, and processing circuitry for creating the conference room and what are referred to herein as “whisper rooms” within the conference room, in which each whisper room is coupled to provide unidirectional or bidirectional communication to/from one of the oil platform operators or radio channels.

To enable the oil platform operators to speak and/or listen to the desired radio channels and/or other oil platform operators, the processing circuitry further creates pseudo-legs between the whisper rooms based on the conferencing instructions. Each of the pseudo-legs provides one-way voice communication between two of the whisper rooms. Voice over Internet Protocol (VoIP) real-time media streams are transmitted between the oil platform operators and radio users through the whisper rooms and pseudo-legs of the conference room.

In one embodiment, the conference server further includes an Internet Protocol (IP) network interface coupled to an IP network over which the VoIP real-time media streams are transmitted and received. The IP network interface is further coupled to a radio network via at least one radio adapter that is configured to convert the VoIP real-time media streams to a format associated with the radio network for delivery to two-way radio devices operated by the radio users.

In a further embodiment, the VoIP real-time media streams include both voice and data to enable data collaboration between oil platform operators. For example, such data collaboration can include instant messaging, presentation sharing, desktop sharing and video.

A communication system for facilitating communication on oil platforms, in yet another embodiment of the present invention, includes an oil platform server that receives operator instructions initiated by oil platform operators and generates conferencing instructions based on the received operator instructions. The system further includes a conference server coupled to the oil platform server via an Internet Protocol (IP) network that receives the conferencing instructions from the oil platform server.

Based on the conferencing instructions, the conference server can create a conference room for managing a conference call between the oil platform operators and radio channels, in which each of the radio channels has a respective group of radio users communicating with each other thereon. The conference room can further include whisper rooms, each associated with one of the oil platform operators or radio channels, and pseudo-legs between whisper rooms to enable each of the oil platform operators to speak and listen to desired radio channels and other oil platform operators. The conference server is operable to process and exchange Voice over Internet Protocol (VoIP) real-time media streams between the oil platform operators and the radio users through the whisper rooms and the pseudo-legs.

In a further embodiment, radio adapters that are coupled to a radio network including two-way radio devices operated by the radio users are coupled to the conference server. Each of the radio adapters communicates with a group of radio users on a respective one of the radio channels, and each of the radio adapters operates to convert media between a first format associated with the radio network and a second format associated with the Internet Protocol (IP) network to transmit and receive the VoIP real-time media streams between the two-way radio devices and the conference server.

In yet a further embodiment, the communication system also includes oil platform control clients running on computing devices operated by the oil platform operators. Each of the oil platform clients is operable to generate respective operator instructions based on input from its oil platform operators. In addition, each of the oil platform control clients provides a graphical user interface to its oil platform operator. The graphical user interface enables the oil platform operator to enter the operator instructions. For example, such operator instructions can include selecting one of the radio channels on which to listen or speak. The oil platform control clients further include a softphone for transmitting and receiving the VoIP real-time media streams.

In another embodiment, the oil platform server maintains time-dependent matrices including real-valued coefficients describing: (a) those oil platform operators that are currently speaking to certain radio channels; (b) the radio channels that are being listened to by certain oil platform operators; and (c) those oil platform operators that are heard by certain other oil platform operators. The oil platform server defines the real-valued coefficients within the time-dependent matrices based on the received operator instructions, and accesses the real-valued coefficients to generate the conferencing instructions to set-up and tear down pseudo-legs and to apply respective gains to each of the pseudo-legs.

A method for facilitating communication on oil platforms, in still another embodiment of the present invention, includes receiving an instruction to establish a conference call between oil platform operators and radio channels, in which each of the radio channels has a respective group of radio users communicating thereon, and creating a conference room for the conference call. The method further includes receiving whisper room instructions to create respective whisper rooms within the conference room for each of the oil platform operators and radio channels and receiving conferencing instructions from the oil platform operators to create pseudo-legs between certain ones of the whisper rooms to enable each of the oil platform operators to speak and listen to desired radio channels and other oil platform operators.

In addition, the method includes establishing a connection between the oil platform operators and radio users/radio channels over an Internet Protocol (IP) network via the conference room. Furthermore, the method includes exchanging Voice over Internet Protocol (VoIP) real-time media streams between the oil platform operators and radio users through the whisper rooms and pseudo-legs.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary communications system for facilitating communication on oil platforms using a conference server, oil platform server and oil platform clients, in accordance with embodiments of the present invention;

FIG. 2 illustrates an exemplary conference server in accordance with embodiments of the present invention;

FIG. 3 illustrates an exemplary oil platform client, oil platform server and conference server, in accordance with embodiments of the present invention;

FIG. 4 illustrates an exemplary operation of a conference room within the conference server, in accordance with embodiments of the present invention;

FIG. 5 illustrates exemplary conference rooms that include whisper rooms, and that have pseudo-legs connecting the whisper rooms and conference rooms, in accordance with embodiments of the present invention;

FIG. 6 illustrates an exemplary conference room including whisper rooms and pseudo-legs for managing a conference call between oil platform operators and radio users; and

FIG. 7 is a flowchart illustrating an exemplary process for facilitating communication on oil platforms, in accordance with embodiments of the present invention.

### DETAILED DESCRIPTION OF THE DRAWINGS

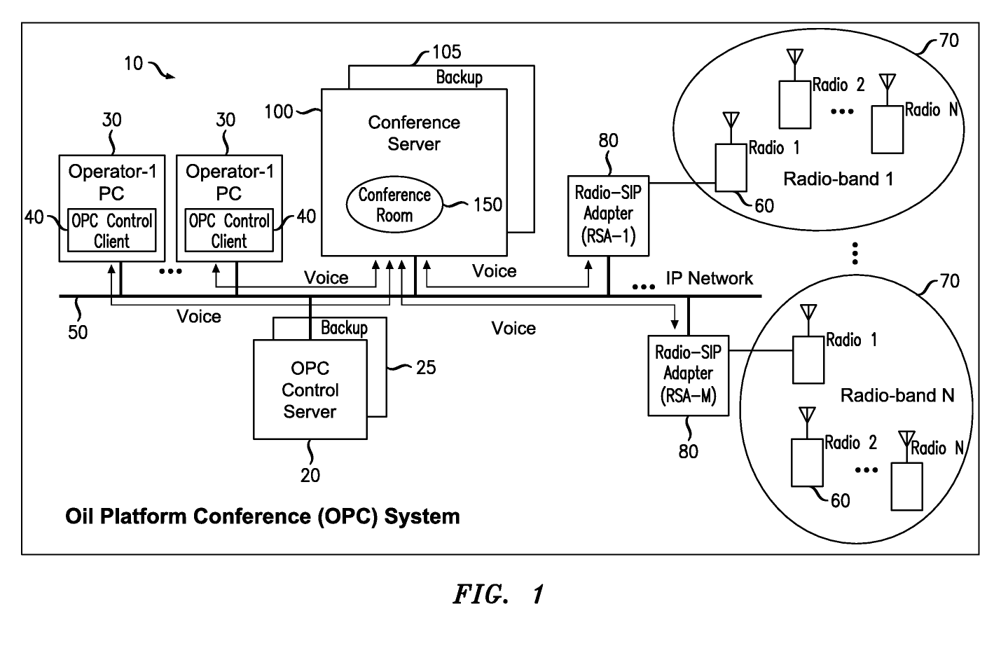

FIG. 1 illustrates an exemplary communication system 10 for facilitating communication on oil platforms, in accordance with embodiments of the present invention. The communication system 10 includes a voice/data conference server 100 providing one or more conference rooms 150 for conference calls. Each conference room 150 is associated with a particular conference call, and is responsible for establishing the different conference legs for the conference call and managing the leg states of the conference legs. For example, the conference room 150 can establish a respective conference leg for each voice and data connection to the conference call, add additional voice and/or data conference legs to the conference call, drop one or more voice and/or data conference legs and mute or un-mute one or more of the voice conference legs.

Although not specifically shown in FIG. 1, multiple conference rooms 150 can exist in parallel. However, voice between conference rooms 150 is not mixed (unless directed by an operator), so that participants in one conference room 150 do not unintentionally hear participants in another conference room 150.

In one embodiment, the conference server 100 creates and manages the conference rooms 150 in specialized conferencing hardware or circuitry. In another embodiment, the conference server 100 creates and manages and conference rooms 150 using a combination of specialized conferencing hardware or circuitry, software and/or firmware. In yet another embodiment, the conference server 100 executes software routines on a standard, general-purpose personal computer (PC) to create and manage the conference rooms 150. In this embodiment, the conference server 100 is designed to enable additional separate general-purpose PCs to be stacked together for increased system scalability and redundancy. As such, no special hardware or circuitry, such as DSP chips and boards and high speed audio busses, is required, thereby minimizing manufacturing costs of the conference server 100.

The conference server 100 is coupled to an Internet Protocol (IP) or other packet-switched data network 50. For example, the data network 50 can be a local area network (LAN), wide area network (WAN), privately managed IP data network, an Internet-based virtual private network (VPN) that uses well-established secure data encryption and authentication methods, such as IPSEC, or a public Internet-based IP data network.

In an exemplary embodiment, the conference server 100 communicates over the data network 50 using an application-level text-based protocol, such as the Session Initiation Protocol (SIP), as described in J. Rosenberg, et al., “SIP: Session Initiation Protocol” RFC: 3261, June 2002, which is hereby incorporated by reference. SIP is an application-layer control protocol used to create, modify and terminate communication (voice, text and/or multimedia) sessions. SIP can be used with other protocols, such as the Real-time Transport Protocol (RTP), the Real-Time Streaming Protocol (RTSP), the Session Description Protocol (SDP), the G.711 and G.729 standards (audio CODECs), and other or additional standards or protocols. As will be appreciated, other or additional protocols and configurations may be used.

The communications system 10 further includes multiple communication devices that are capable of joining conference calls. In accordance with embodiments of the present invention, the communication devices include oil platform operator communication devices and two-way radio devices. For example, as shown in FIG. 1, oil platform operator personal computers (PCs) 30 are communicatively coupled to the conference server 100 via the IP network 50, while a plurality of two-way radio devices 60 within radio networks 70 are communicatively coupled to the conference server 100 via Radio-SIP Adapters (RSAs) 80. The oil platform PCs 30 each include an oil platform conference (OPC) control client 40 that provides an IP phone or softphone on the PC 30. Thus, each oil platform operator is able to listen and speak to other oil platform operators and radio users via the OPC control client 40. In addition, the OPC control client 40 enables data collaboration between PCs 30 during the conference call, such as instant messaging, presentation sharing, desktop sharing and video. Moreover, the OPC control client 40 allows operators to use a wide variety of commercially-available PC-based headsets and microphones, and to interface directly with other systems on the oil platform, such as a PBX and overhead paging speakers.

The two-way radio devices 60 within the radio network 70 communicate with each other over a radio band (Radio-band 1) having a particular frequency, type of channel and modulation format. Thus, each two-way radio device 60 within the radio network 70 that is tuned to Radio-band 1 is able to speak and listen to other two-way radio devices 60 within the radio network 70 that also are tuned to Radio-band 1. Likewise, each two-way radio device 60 within the radio network 70 that is tuned to Radio-band N is able to speak and listen to other two-way radio devices 60 within the radio network 70 that also are tuned to Radio-band N. In a typical scenario, a user depresses a push-to-talk button on their two-way radio device 60 to speak to one or more other two-way radio users in the radio network 70.

For example, if there are two users within the radio network 70 whose two-way radio devices 60 are tuned to Radio-band 1, when the first user depresses the push-to-talk button associated with Radio-band 1, the first user is able to speak directly to the second user without requiring the usual call setup procedures, such as dialing, ringing and answering. As another example, assuming there are three or more users forming a user group within the radio network 70 whose two-way radio devices 60 are tuned to Radio-band 1, when one of the users in the group depresses the push-to-talk button, that user is able to speak directly to all of the other users in that group. Thus, in the group scenario, all members of the group are able to simultaneously hear one user.

However, two radio users are not able to simultaneously depress their individual push-to-talk buttons. As a result, in a radio network 70, only one user can be heard at a time. A second user must wait for a first user to finish speaking and release their push-to-talk button before the second user can commence speaking. Thus, the second user and all other users in the group are typically locked out and cannot barge-in while the first user is speaking.

To connect the two-way radio devices 60 in a particular radio network (i.e., on a particular radio channel, such as Radio-band 1) to a conference call with one or more oil platform operators, one of the two-way radio devices 60 (e.g., Radio 1 within Radio-band 1) is connected to an RSA 80. The RSA 80 operates to convert voice and/or data between the format associated with the radio network 70 (e.g., Radio-band 1) and the format associated with the IP data network 50 (e.g., SIP and VoIP). For example, in embodiments in which the voice/data conference server 100 is SIP-based, the RSA 80 can transmit SIP messages to the voice/data conference server 100 to initiate a conference call and/or join an existing conference call.

In general, a conference participant initiates a conference call by providing an instruction to the conference server 40 that causes the conference server 40 to create a conference room 150 for the conference call. In one embodiment, the conference participant generates the instruction by operating a console that can invite multiple RSAs 80, and OPC control clients 40 to the conference. For example, an oil platform operator can provide the instruction to the conference server 100 via a graphical user interface (GUI) on their PC 30 that provides a conference application program interface (API) via the OPC control client 40 to the conference server 100. In this embodiment, the RSAs may automatically answer, or alternately, one of the radio users may be required to accept the invite, for example, by depressing one or more dual tone multi-frequency (DTMF) keys on their two-way radio 60. Only one radio user need to accept for all radio users in the group.

Once the conference server 100 receives the instruction from a conference participant to initiate a conference call, the conference server creates a conference room 150 for the conference call. The conference room 150 operates to establish and manage the conference call. Thus, the conference room 150 generates messages to invite conference participants (e.g., OPC control clients 40 and RSAs 80) to join the conference call, establishes a separate conference leg for each voice and data connection to the conference call, mixes incoming voice (Voice over Internet Protocol (VoIP) media streams) received from the conference participants and transmits the mixed VoIP media streams back out to the conference participants via unicast data packets, provides various data conferencing services to the conference participants during the conference call, such as instant messaging, presentation sharing, desktop sharing and video, and implements various policies for managing the conference legs of the conference call (e.g., muting or un-muting one or more participants, adding and/or dropping one or more participants). The conference room 150 is further operable to release one or more participants from the conference call either upon request from the participant (e.g., hang-up or via GUI) or based upon a policy associated with the conference call (e.g., based on a pre-determined time of release, occurrence of an event or action of another participant).

In an exemplary operation of the conference room 150, if during the conference call involving Operator-1, Operator-2 and RSA-1, the conference room 150 simultaneously receives voice from Operator-I PC 30 and RSA-1 80, the conference room 150 mixes the voice and transmits the mixed voice back out to Operator-2 PC 30. To avoid echos, the conference room 150 transmits only the voice from RSA-1 80 to Operator-I PC 30 and transmits only the voice from Operator-I to RSA-1 80. As explained above, two or more radio participants are not able to simultaneously depress their individual push-to-talk buttons on their two-way radio devices 60. Therefore, each RSA 80 only transmits voice to the conference room 150 from one radio participant at a time. However, for voice received from the conference room 150, RSA-1 80 is able to transmit the received voice over Radio-band 1 via the attached two-way radio device 60 to multiple two-way radio devices 60 listening within the same band (Radio-band 1) regardless of whether another radio participant is speaking.

Since oil platform conferencing requires some participants (operators) to speak to groups of other participants (radio channels), while only allowing these other participants (radio channels) to speak to a single or a subset of the operator participants, the communication system 10 further includes an oil platform conference (OPC) control server 20 that accommodates all of the different conferencing scenarios. The OPC server may be, for example, a general purpose PC. The OPC control server 20 issues commands over the IP network to the conference server 100 to achieve fine-grain control of its internal conferencing engine. In general, the OPC control server 20 is responsible for communicating with the conference server 100 to setup, control and monitor the oil platform conferences within the conference server 100. The OPC control server 20 is also responsible for sending and receiving commands to and from each OPC control client 40 on each operator's PC 30.

For example, the OPC control server 20 can issue commands to the conference server 100 based on input (operator instructions) from the operators. For example, one operator may not want his/her voice to be heard by other operators, or to be privately directed to channel radio users. In addition, operators may need to exchange documents and images (e.g., real-time video camera images, such as the video camera image associated with one of the active radio channels) with each other, as well as send instant messages while voice conferencing with the platform workers (radio users). Operators may also want to create and manage recordings of conversations and to play pre-recorded messages and instructions.

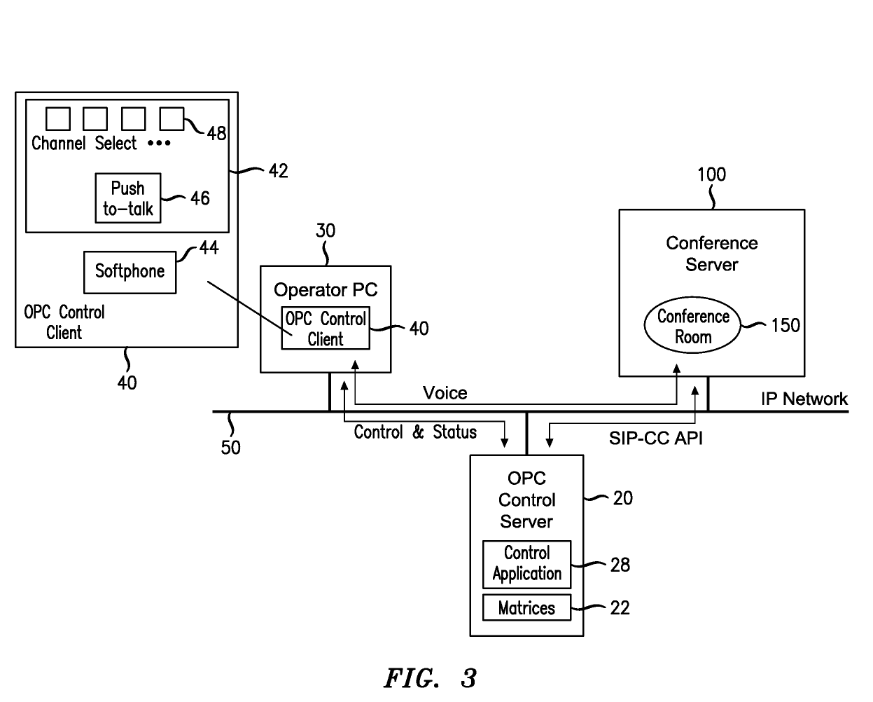

To enable operator control over an oil platform conference room 150, the OPC control server 20 utilizes three time-dependent matrices that describe (a) which operators are currently speaking, (b) which operators are heard by other operators and (c) which channels are heard by each operator. The OPC control server 20 updates these three matrices based on operator instructions received from the OPC control clients 40 and references these three matrices in order to set-up and tear-down the appropriate connections within the oil platform conference room 150 of the conference server 100. The OPC control server 20 manages control of the oil platform conference room 150 by issuing a series of conferencing instructions that depend upon the coefficients within these three matrices, as will be described in more detail below in connection with FIG. 3.

Both the conference server 100 and the OPC control server 20 have secondary servers 105 and 25, respectively, for reliability and failover. If an OPC control client 40 detects that the primary OPC control server 20 has gone offline or has failed, it automatically uses the secondary OPC control server 25 until such time that the primary OPC control server comes back online. Similarly, if the OPC control server 20 detects that the primary conference server 100 has gone offline or has failed, it automatically uses the secondary conference server 105. If the conference server 100 fails during active conferences, the voice mixing operation will cease and conferences are automatically re-initialized and established on the secondary conference server 105.

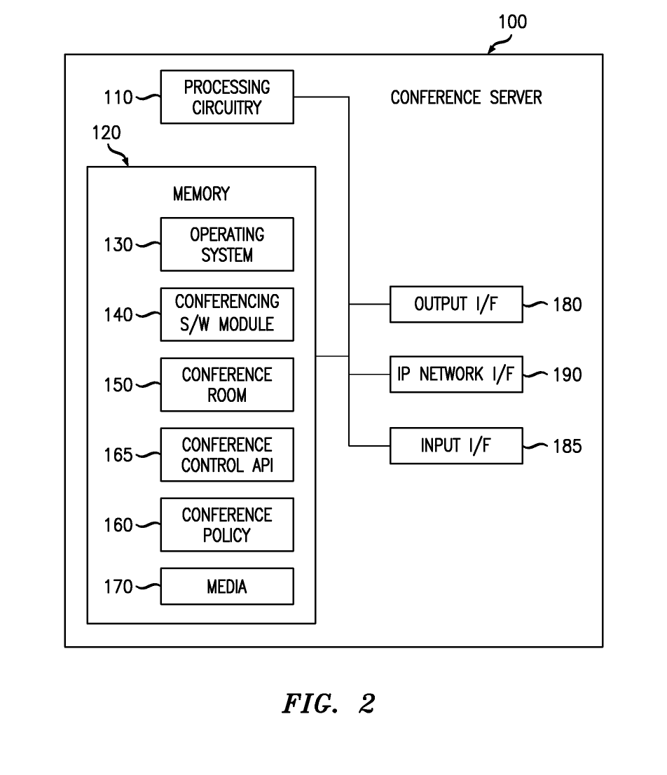

Referring now to FIG. 2, the conference server 100 will now be described in more detail. The conference server 100 includes processing circuitry 110, a memory 120 and various interfaces 180, 185 and 190. For example, to check the status of the conference server (e.g., troubleshoot problems, receive status reports, etc.), the interfaces can include an input interface 185 coupled to receive input from an input device, such as a keyboard, mouse, IP network or other similar input device and an output interface 180 coupled to provide status information to an output device, such as a display, speakers, printer, IP network or other output device. In addition, an IP network interface 190 is connected to transmit and receive media (e.g., VoIP media streams and/or data) to and from IP conference devices (e.g., the OPC control client and RSA of FIG. 1).

The memory 120 includes an operating system 130 and a conferencing software module 140. The processing circuitry 100 includes one or more processors that are capable of executing the operating system 130 and the conferencing software module 140. As used herein, the term “processor” is generally understood to be a device that drives a general-purpose computer, such as a PC. It is noted, however, that other processing devices, such as microcontrollers, Field Programmable Gate Arrays (FPGAs), Application Specific Integrated Circuits (ASICs), or a combination thereof, can be used as well to achieve the benefits and advantages described herein. The memory 120 includes any type of data storage device, including but not limited to, a hard drive, random access memory (RAM), read only memory (ROM), flash memory, compact disc, floppy disc, ZIP® drive, tape drive, database or other type of storage device or storage medium.

In a general operation of the conference server 100, the processing circuitry 110 accesses and runs the conferencing software module 140 to initiate and control a conference call between multiple participants. For example, during execution of the conferencing software module 140, the processing circuitry 110 is operable to receive instructions for creating a conference room 150 for a conference call via a conference control application program interface (API) 165, to create such a conference room 150 in the memory device 120 for the conference call and to connect the conference participants together in a conference call (i.e., establish the conference legs for the conference call) via the conference room 150. Once the conference room 150 is established, in an exemplary embodiment, the conference room 150 receives incoming media (e.g., VoIP media streams and/or data) from the conference participants via IP network I/F 190, processes the received media using the processing circuitry 110 and transmits the processed media 170 (e.g., mixed voice and/or data) back out to the conference participants during the conference call.

In addition, the conference room 150 and/or processing circuitry 110 can access one or more conference policies 160 to control and/or manage the conference call. Once accessed, the processing circuitry 110 performs routines dictated by the policies 160. The conference policy 160 may be predefined or received from one of the conference participants (e.g., oil platform operator) via the conference control API 165. For example, in an exemplary embodiment, the policy 160 may identify one or more conference participants to be included in the conference call. In another exemplary embodiment, the policy 160 may control muting or un-muting of one or more participants during the conference call.

Referring now to FIG. 3, a more detailed explanation of the operation of the OPC control client 40, OPC control server 20 and conference server 100 is provided. As shown in FIG. 3, the OPC control client 40 executes on each operator's PC 30 and provides the operator with a graphical user interface 42 on a touch-screen. The touch screen GUI 42 allows each operator to log into their OPC control client 40, manage his/her preferences, such as the default listening channel, select particular channels 48 to be heard, to depress a graphical push-to-talk button 46 and to visually see which of the multiple channels currently has voice activity.

With the voice activity display, in addition to hearing the voice, the operator gets a visual indication of the corresponding associated radio channel. In exemplary embodiments, the touch-screen also displays real-time video within one or more windows, and may also provide access to additional features, such as creating and managing recordings, playing pre-recorded messages and connecting to other communication systems on the oil platform, such as the PBX and overhead paging speakers.

The OPC control client 40 also contains a SIP softphone (or IP phone) 44 that allows the operator to exchange VoIP with other operators and with radio users via the conference server 100. Therefore, there is no need for the operator to have a separate PBX telephone set, and in some situations, there may not be a need at all for a PBX within the entire oil platform system.

The OPC control server 20 exchanges messages with the OPC control client 40 via the IP network 50. For example, such messages may include operator instructions from the OPC control client 40 to speak and/or listen to a particular radio channel or a particular operator or to provide data to a particular operator. In addition, the OPC control server 20 exchanges messages with the conference server via the IP network 50 through the conference control API shown in FIG. 2. In one embodiment, the conference control API is a SIP-CC API, and the OPC control server 20 manages control of the oil platform conference room 150 within the conference server 100 by issuing a series of SIP-CC API calls to the conference server 100.

To manage the oil platform conference room 150, the OPC control server 20 maintains a set of three time-dependent matrices 22 and executes a conference control application 28. As part of the conference control application 28, the OPC control server 20 defines the coefficients in the three time-dependent matrices 22 (referred to hereinafter as matrices F, G and H) based upon three conditions (as determined by operator instructions provided by the OPC control clients 40): (a) which operators are currently speaking to which channels; (b) which channels each operator listens to; and (c) whether or not an operator intends his/her voice to be private, i.e., heard by other operators, or not.

Matrix F represents a mapping between operators speaking and channels listening, and is of size N×M, where N is the number of radio channels and M is the number of operators. The matrix F is entirely zero unless one or more operators are speaking. If the i^{th} operator is speaking, the i^{th} column of F designates the set of channels to whom this operator is speaking. For example, if the i^{th} operator speaks only to the single j^{th} channel, the i^{th} column is entirely zero except for the j^{th} element, which is set to unity. If this same i^{th} operator intends to speak to multiple channels, the appropriate elements of F are created in this way. When the i^{th} operator releases his push-to-talk button, the corresponding i^{th} column of F is reset back to zero. As another example, if the ij^{th} element of F is 1, this designates that users listening to the i^{th} radio channel hear the j^{th} operator speaking.

Matrix G represents a mapping between operators speaking and operators listening, and is of size M×M, where M is the number of operators. The matrix G is entirely zero unless one or more operators are speaking. If the i^{th} operator is speaking, the i^{th} column of G represents the set of operators who hear this. For example, if the ij^{th} element of G is 1, this specifies that the i^{th} operator hears the j^{th} operator speaking. Since operators never hear themselves through the conference room 150, the i^{th} element of the i^{th} column is always zero. That is, the diagonal elements of G are always zero. Typically, when an operator speaks, he is heard by all other operators so that this i^{th} column of G is all 1's, except for the it element. However, if this i^{th} operator intends for his call to be private, i.e., heard only by radio channels and not other operators, the i^{th} column of G is set to 0. If multiple operators speak at the same time, multiple columns of G are created in this way. When the i^{th} operator releases his push-to-talk button, the corresponding i^{th} column of G is reset back to zero.

Matrix H represents a mapping between radio channels speaking and operators listening, and is of size M×N, where M is the number of operators and N is the number of channels. The coefficients in H are determined by the set of channels each operator intends to listen to. The i^{th} row of H prescribes the set of channels being listened to by the i^{th} operator. For example, if the first element of the i^{th} row is 1, channel 1 is heard, if the j^{th} element of this row is 1, the j^{th} channel is heard, etc. In other words, if the ij^{th} element of H is 1, this denotes that the i^{th} operator hears the voice spoken in the j^{th} radio channel. Unlike matrix F and G, this matrix is not zero, since operators typically listen to one or more channels. When an operator speaks, the i^{th} row of H must be multiplied by a scale factor α so that while this i^{th} operator speaks, he listens to his set of channels at a reduced level of volume. If multiple operators speak at the same time, multiple rows of H are modified by the scale factor α in this way. When the i^{th} operator releases his push-to-talk button, the corresponding i^{th} row of H is reset back to the quiescent values that prescribe the set of channels being listened to by this operator, i.e., the scale factor is reset to 1.

As such, the voice mixing operation at any given time within the conference room 150 can be expressed as:

$$( \begin{matrix}{\vec{l}}_{o} \\ {\vec{l}}_{c}\end{matrix} ) = ( \begin{matrix}G & H \\ F & 0\end{matrix} ) ( \begin{matrix}{\vec{s}}_{o} \\ {\vec{s}}_{c}\end{matrix} ) , \qquad ( Equation 1 )$$

where \vec{l}ₒ represents the set of M operator listeners, \vec{l}_{c} represents the set of N channel listeners, \vec{s}ₒ represents the set of M operator speakers and \vec{s}_{c} represents the set of N channel speakers. In the oil platform conference application, channels do not hear other channels, as also expressed by the N×N matrix of 0's in the lower right portion of the matrix in Equation 1.

Thus, the \vec{l}ₒ and \vec{l}_{c} column vectors represent discrete-time sampled representations of the analog voice signals heard by participants, while the \vec{s}ₒ and \vec{s}_{c} column vectors represent discrete-time sampled representations of the analog voice signals spoken by participants. For example, the j^{th} element of \vec{s}ₒ is a discrete-time sampled signal corresponding to the actual analog signal sₒⱼ(t), spoken by the j^{th} speaker. Similarly, the i^{th} element of \vec{l}ₒ is a discrete-time sampled signal corresponding to the actual analog signal lₒᵢ(t) heard by the i^{th} listener. A typical sampling rate for telephone quality speech is 8 kHz, so that each vector of values \vec{l}ₒ, \vec{l}_{c}, \vec{s}_{c} and \vec{s}ₒ occurs 125 μsec later in time than the previous vector of values. However, faster sampling rates can also be used so that the listener and speaker vectors represent speech signals with higher fidelity and quality.

In Equation 1, it is assumed that the i^{th} element of \vec{l}ₒ and the i^{th} element of \vec{s}ₒ correspond to the same participant, i.e., to the i^{th} operator. That is, lₒᵢ(n) represents what the i^{th} operator hears, and sₒᵢ(n) represents what this same i^{th} operator says. Similarly, it is assumed that the i^{th} element of \vec{l}_{c} and the i^{th} element of \vec{s}_{c} correspond to the same participant, i.e., to the i^{th} radio channel. That is, l_{ci}(n) represents what users with radio tuned to the i^{th} channel hear, and s_{ci}(n) represents the speech spoken by any user in the i^{th} channel.

From Equation 1, it can also be seen that:

\vec{l}ₒ=G\vec{s}ₒ+H\vec{s}_{c} (Equation 2)

and that

\vec{l}_{c}=F\vec{s}ₒ. (Equation 3)

That is, the operators hear a linear combination (determined by matrix G) of other operators plus a linear combination (determined by matrix H) of channels, whereas the channels hear only a linear combination of operators (determined by the matrix F) and not other channels.

Referring again to FIG. 3, the OPC control server 20 populates the coefficients within the matrices 22 based on the operator instructions received from the OPC control clients 40, oil platform policies and operator preferences. In addition, the OPC control server 20 uses the matrix coefficients when running the control application 28 to generate a set of conferencing instructions to the conference control API in the conference server 100. For example, if no operators are speaking:

\vec{l}ₒ=H₀\vec{s}_{c} (Equation 4)

and

\vec{l}_{c}=0. (Equation 5)

The coefficients of H₀ in Equation (4) are determined by the selection of channels to heard by operators. Specifically, H₀ can be written as:

$${H}_{0} = ( \begin{matrix}{\vec{h}}_{1}^{T} \\ {\vec{h}}_{2}^{T} \\ … \\ {\vec{h}}_{M}^{T}\end{matrix} ) . \qquad ( Equation 6 )$$

The N coefficients in the vector h₁ designate which of the N channels operator 1 should hear, the N coefficients in the vector h₂ designate which of the N channels operator 2 should hear, and so forth up to the vector h_{M} designating which of the N channels operator M should hear. Typically, the coefficients in these vectors are determined by the oil platform policies, and by operator preferences. For example, if operator i should listen to the j^{th} channel, the j^{th} element of \vec{h}ᵢ^{T} should be set to 1. When no operators are speaking the matrices G₀ and F₀ contain all 0's.

As another example, if operator 1 is speaking, then

$$\begin{matrix}( \begin{matrix}{\vec{l}}_{o} \\ {\vec{l}}_{c}\end{matrix} ) = ( \begin{matrix}{G}_{1} & {H}_{1} \\ {F}_{1} & 0\end{matrix} ) ( \begin{matrix}{\vec{s}}_{o} \\ {\vec{s}}_{c}\end{matrix} ) \\ so that & ( Equation 7 ) \\ {\vec{l}}_{o} = {G}_{1} {\vec{s}}_{o} + {H}_{1} {\vec{s}}_{c} \\ and & ( Equation 8 ) \\ {\vec{l}}_{c} = {F}_{1} {\vec{s}}_{o} \\ where & ( Equation 9 ) \\ {G}_{1} = ( \begin{matrix}0 & 0 & 0 & … & 0 \\ 1 & 0 & 0 & … & 0 \\ … & … & … & … & 0 \\ 1 & 0 & 0 & … & 0\end{matrix} ) & ( Equation 10 ) \\ {H}_{1} = ( \begin{matrix}α {\vec{h}}_{1}^{T} \\ {\vec{h}}_{2}^{T} \\ … \\ {\vec{h}}_{M}^{T}\end{matrix} ) \\ and & ( Equation 11 ) \\ {F}_{1} = ( {\vec{f}}_{1} \vec{0} … \vec{0} ) & ( Equation 12 )\end{matrix}$$

The first column of G₁ is all 1's except for the first element designating that operator 1 speaks to all other operators except himself. If operator 1 then wishes to make a private announcement that is heard by his selected channels, but not by any other operator, a new matrix G_{1*} can be designated as an M×M matrix of zeroes. The matrix H₁ resembles H₀ in Equation (6) except that the first row is multiplied by the scale factor α so that while operator 1 is talking he hears his set of specified channels reduced in level by the scale factor α.

The vector \vec{f}₁ specifies the sets of channels that operator 1 speaks to when he pushes his push-to-talk button. Typically, this is only a single designated channel so that \vec{f}₁=(0 0 . . . 1 . . . 0)^{T}. However, in some cases, an operator might select more than one channel in which to speak, so that \vec{f}₁ has the form \vec{f}₁=(1 0 . . . 1 . . . 1)^{T} designating the set of multiple channels that are being spoken to by this operator. \vec{f}₁ can also have the form \vec{f}₁=(1 1 . . . 1 . . . 1)^{T} if operator 1 wishes to speak to all of the channels.

As yet a further example, if operators 1 and 2 are both speaking, then:

$$\begin{matrix}( \begin{matrix}{\vec{l}}_{o} \\ {\vec{l}}_{c}\end{matrix} ) = ( \begin{matrix}{G}_{12} & {H}_{12} \\ {F}_{12} & 0\end{matrix} ) ( \begin{matrix}{\vec{s}}_{o} \\ {\vec{s}}_{c}\end{matrix} ) \\ so that & ( Equation 13 ) \\ {\vec{l}}_{o} = {G}_{12} {\vec{s}}_{o} + {H}_{12} {\vec{s}}_{c} \\ and & ( Equation 14 ) \\ {\vec{l}}_{c} = {F}_{12} {\vec{s}}_{o} \\ where & ( Equation 15 ) \\ {G}_{12} = ( \begin{matrix}0 & 1 & 0 & … & 0 \\ 1 & 0 & 0 & … & 0 \\ … & 1 & … & … & 0 \\ 1 & 1 & 0 & … & 0\end{matrix} ) & ( Equation 16 ) \\ {H}_{12} = ( \begin{matrix}α {\vec{h}}_{1}^{T} \\ α {\vec{h}}_{2}^{T} \\ … \\ {\vec{h}}_{M}^{T}\end{matrix} ) \\ and & ( Equation 17 ) \\ {F}_{12} = ( {\vec{f}}_{1} \vec{{f}_{2}} … \vec{0} ) & ( Equation 18 )\end{matrix}$$

The matrix G₁₂ has the first two columns set to unity except for the diagonal elements so that all operators hear operator 1 and operator 2 speaking, except those operators do not hear themselves. The matrix H₁₂ resembles H₀ in Equation (6) except that the first and second rows are now multiplied by the scale factor α so that while operator 1 is talking he hears his set of listener channels reduced in level by the scale factor α, and while operator 2 is talking he also hears his set of listener channels reduced in level by the scale factor α. If operator 2 wishes his call to be private, the matrix G₁₂ can be written as:

$${G}_{12} = ( \begin{matrix}0 & 0 & 0 & … & 0 \\ 1 & 0 & 0 & … & 0 \\ … & 0 & … & … & 0 \\ 1 & 0 & 0 & … & 0\end{matrix} ) \qquad ( Equation 19 )$$

so that the second column G₁₂ of is all zeroes.

In still a further example, if operators a, b . . . k are speaking, then:

$$\begin{matrix}( \begin{matrix}{\vec{l}}_{o} \\ {\vec{l}}_{c}\end{matrix} ) = ( \begin{matrix}{G}_{a , b … k} & {H}_{a , b … k} \\ {F}_{a , b … k} & 0\end{matrix} ) ( \begin{matrix}{\vec{s}}_{o} \\ {\vec{s}}_{c}\end{matrix} ) \\ so that & ( Equation 20 ) \\ {\vec{l}}_{o} = {G}_{a , b … k} {\vec{s}}_{o} + {H}_{a , b … k} {\vec{s}}_{c} \\ and & ( Equation 21 ) \\ {\vec{l}}_{c} = {F}_{a , b … k} {\vec{s}}_{o} \\ where & ( Equation 22 ) \\ {G}_{a , b … k} = ( \begin{matrix}0 & 1 & … & 1 & … & 1 & 0 \\ 0 & 1 & … & 1 & … & 1 & 0 \\ 0 & 1 & … & 1 & … & 1 & 0\end{matrix} ) & ( Equation 23 ) \\ {H}_{a , b … k} = ( \begin{matrix}{\vec{h}}_{1}^{T} \\ … \\ α {\vec{h}}_{b}^{T} \\ … \\ α {\vec{h}}_{a}^{T} \\ … \\ α {\vec{h}}_{k}^{T} \\ … \\ {\vec{h}}_{M}^{T}\end{matrix} ) \\ and & ( Equation 24 ) \\ {F}_{a , b … k} = ( \begin{matrix}\vec{0} & … & {\vec{f}}_{a} & … & {\vec{f}}_{b} & … & {\vec{f}}_{k} & \vec{0} & …\end{matrix} ) & ( Equation 25 )\end{matrix}$$

The matrix G_{a,b . . . k} has the columns a, b . . . k set to unity except for its diagonal elements, so that all operators hear operators a, b . . . k except that these operators do not hear themselves. The matrix H_{a,b . . . k} resembles H₀ in Equation (6) except that rows a, b . . . k are now multiplied by the scale factor α so that while operator a is talking he hears his set of listener channels reduced in level by the scale factor α, while operator b is talking he hears his set of listener channels reduced in level by the scale factor α, and so forth for the remainder of the operators in the set a, b . . . k. If operator b wishes his call to be private, the matrix G_{a,b . . . k} can be written as:

$${G}_{a , b … k} = ( \begin{matrix}0 & 1 & … & 0 & … & 1 & 0 \\ 0 & 1 & … & 0 & … & 1 & 0 \\ 0 & 1 & … & 0 & … & 1 & 0\end{matrix} ) \qquad ( Equation 26 )$$

so that the b^{tj} column is to zero designating that the b^{th} operator speaks only to his specified set of listeners and not to other operators.

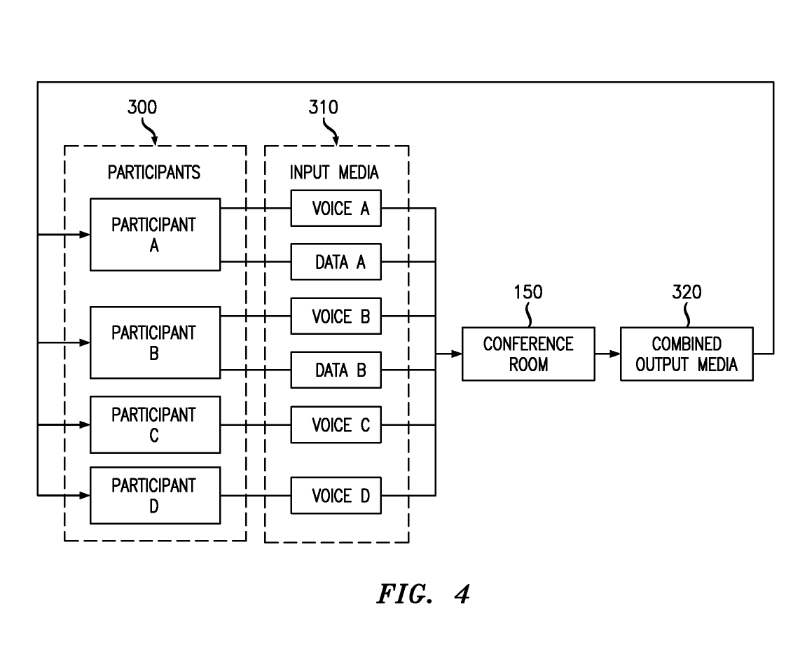

FIG. 4 illustrates an exemplary voice mixing operation of a conference room 150 in accordance with embodiments of the present invention. In FIG. 4, multiple participants 30 (A, B, C and D) are engaged in a conference call via the conference server 100 and are coupled to transmit input media 310 to the conference room 150 and receive output media 320 from the conference room 150. Participants A and B, which may be for example operators, have both a voice connection (voice conference leg) and a data connection (data conference leg) to the conference room 150, while Participants C and D, which may be for example radio channels, have only a voice connection (voice conference leg) to the conference room 150. Thus, Participant A is capable of transmitting both voice (Voice A) and data (Data A) to the conference room 150, Participant B is capable of transmitting both voice (Voice B) and data (Data B) to the conference room 150, Participant C is capable of transmitting voice (Voice C) to the conference room 150 and Participant D is capable of transmitting voice (Voice D) to the conference room 150.

As described above, the conference room operates to combine the input media received from all participants 300 and transmit the combined media 320 back out to the participants. For example, if during the conference call, the conference room 150 simultaneously receives voice from Participant A (Voice A) and Participant D (Voice D), the conference room 150 mixes the voice and transmits the mixed voice back out to Participants B and C. To avoid echos, the conference room 150 transmits only the voice from Participant D to Participant A and transmits only the voice from Participant A to Participant D. Likewise, if the conference room 150 receives both voice (Voice A) and data (Data A) from Participant A, the conference room will transmit both the voice (Voice A) and data (Data A) to Participant B, while transmitting only the voice (Voice A) to Participants C and D.

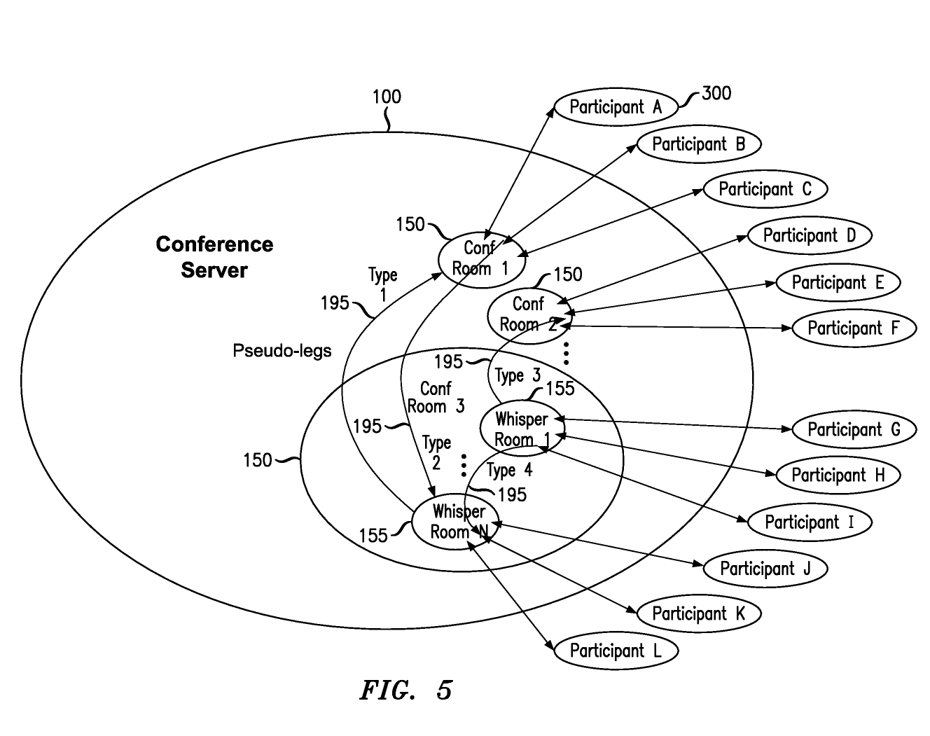

FIG. 5 illustrates exemplary conference rooms 150 that include whisper rooms 155, and that have pseudo-legs 195 connecting the whisper rooms 155 and conference rooms 150, in accordance with embodiments of the present invention. The term “whisper room” as used herein is defined as a conference room within a conference room. A whisper room 155 is identified by its conference room number and whisper room number. For example, in FIG. 5, there are three conference rooms (Conference Room 1, Conference Room 2 and Conference Room 3). Each conference room manages a conference call for the participants connected to that conference room. For example, Conference Room 1 manages a conference call for Participants A, B and C, while Conference Room 2 manages a conference call for Participants D, E and F. However, Conference Room 3 has a plurality of whisper rooms (Whisper Room 1 . . . Whisper Room N) therein. Since each whisper room operates as an individual conference room, Whisper Room 1 manages a conference call for Participants G, H and I, while Whisper Room N manages a conference call for Participant J, K and L.

Voice between conference rooms 150 and whisper rooms 155 is typically not mixed, so that participants in one conference room 150 or whisper room 155 do not unintentionally hear participants in another conference room 150 or whisper room 155. However, in accordance with embodiments of the present invention, a participant in one conference room 150 or whisper room 155 is able to speak and/or listen to one or more participants in one more other conference rooms 150 or whisper rooms 155 by using pseudo-legs 195.

The term “pseudo-leg” as used herein is defined as a voice connector leg formed internally within the conference server 100. The voice connector leg can connect two conference rooms 150, two whisper rooms 155, a conference room and a whisper room, a conference leg (i.e., one of the conference participants 300) to another conference leg (i.e., another one of the conference participants 300) or a conference leg to a whisper room 155 or conference room 150.

More specifically, four types of pseudo-legs (PLs) 195 are illustrated in the conference server 100 of FIG. 5. The first type (Type 1 PL) is a one-way audio path between a conference room 150 or whisper room 155 and another conference room 150 or whisper room 155 (everything spoken in the starting conference room is heard in the ending conference room). In FIG. 5, the Type 1 PL connects Whisper Room N with Conference Room 1, so that Participants A, B and C are able to hear Participants J, K and L.

A Type 2 PL is a one-way audio path between a conference leg and a conference room (everything spoken in the starting leg is heard in the ending conference room). In FIG. 5, the Type 2 PL connects Participant B with Whisper Room N, so that Participants J, K and L in Whisper Room N are able to hear Participant B. A Type 3 PL is a one-way audio path between a conference room and a conference leg (everything spoken in the starting conference room is heard in the ending leg). In FIG. 5, the Type 3 PL connects Whisper Room 1 with Participant E, so that Participant E is able to hear Participants G, H and I in Whisper Room 1. A Type 4 PL is a one-way audio path between one conference leg and another conference leg (everything spoken in the starting leg is heard in the ending leg). In FIG. 5, the Type 4 PL connects Participant I with Participant K, so that Participant K is able to hear Participant I.

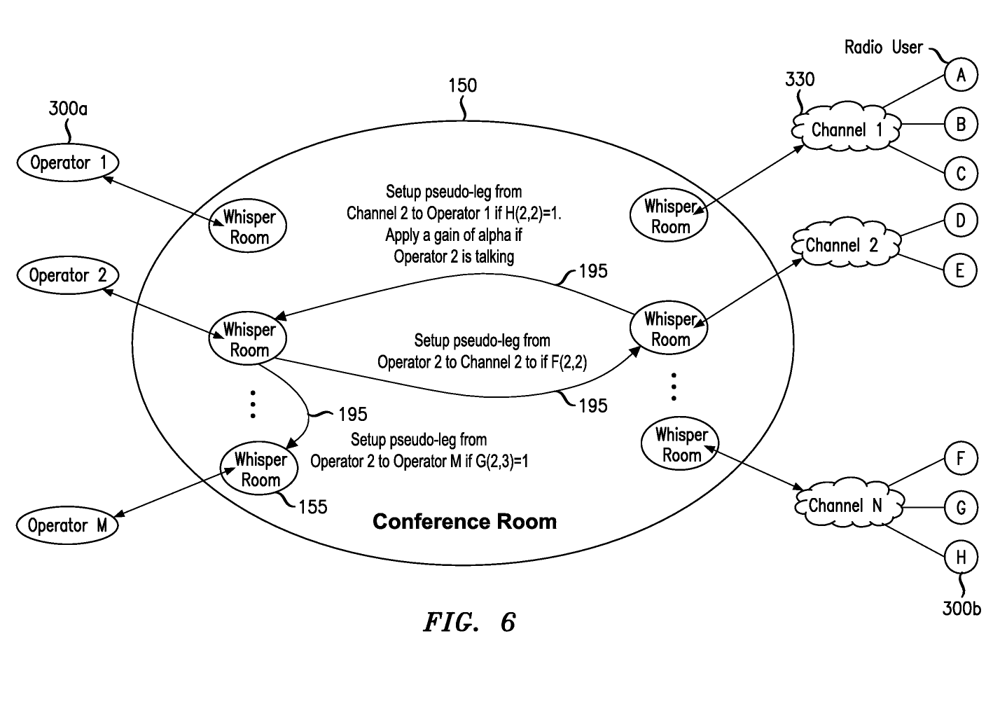

In an exemplary embodiment, in order to enable oil platform operators to speak to radio users on one or more radio channels while enabling the radio users to speak only to a single or subset of operators, a single conference room 150 with multiple whisper rooms 155 and Type 1 PLs can be used. For example, as shown in FIG. 6, a single conference room 150 within a conference server is able to effectively manage a conference call involving multiple oil platform operators 300a and multiple radio users 300b on multiple radio channels 330. Within the conference room 150 there are a series of N channel whisper rooms, each connected via the IP network to an RSA that communicates with multiple radio users 300b on a particular radio channel 330, and a series of M operator whisper rooms, each connected via the IP network to a softphone on a PC utilized by an operator 300a.

The OPC control server scans through the entire set of elements in matrices F, G, H whenever there is a change to one or more of these elements. For example, if element F(2,2) is 1, as shown in FIG. 6, a pseudo-leg created from the operator 2 whisper room 155 to the channel 2 listening room 155. If element F(2,2) changes to 0, any existing pseudo-leg from the operator 2 whisper room to the channel 2 listening room is deleted. If element G(2,M) is 1, as shown in FIG. 6, a pseudo-leg is created from the operator 2 whisper room to the operator M listening room. If element G(2,M) changes to 0, any existing pseudo-leg from the operator 2 whisper room to the operator M listening room is deleted. Likewise, if element H(2,2) is 1, as shown in FIG. 6, a pseudo-leg created from the channel 2 whisper room 155 to the operator 2 listening room 155. If element H(2,2) changes to 0, any existing pseudo-leg from the channel 2 whisper room to the operator 2 listening room is deleted

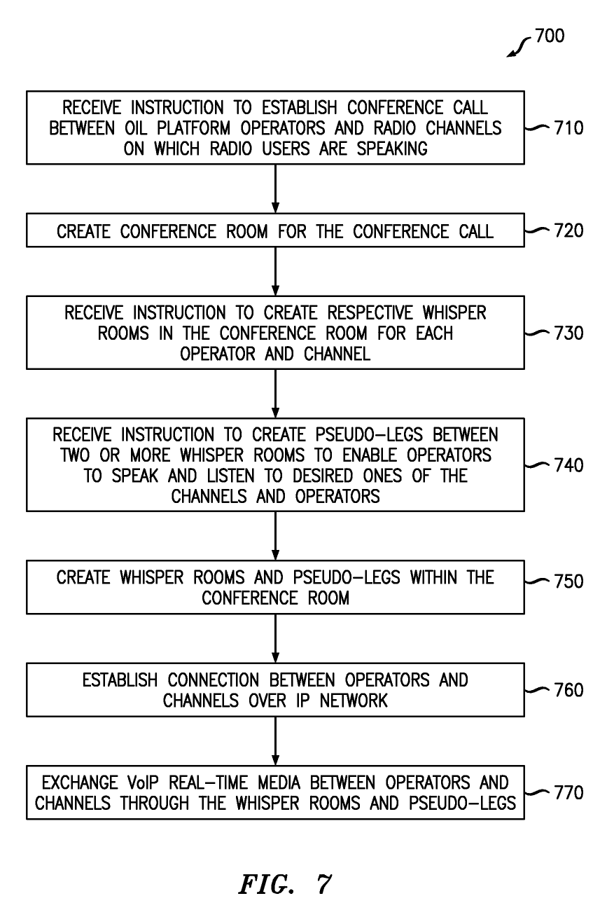

FIG. 7 is a flowchart illustrating an exemplary process 700 for facilitating communication on oil platforms, in accordance with embodiments of the present invention. The process begins at block 710, where an instruction to establish a conference call between oil platform operators and radio channels on which radio users are speaking is received, and in response thereto, at block 720, a conference room for the conference call is created.

At block 730, instructions are received to create respective whisper rooms in the conference room for each oil platform operator and each radio channel. In addition, at block 740, instructions are received to create pseudo-legs between two or more whisper rooms to enable the oil platform operators to speak and listen to desired ones of the radio channels and other operators. Upon receiving the instructions, at block 750, the whisper rooms and requested pseudo-legs are created within the conference room, and at block 760, a connection is established between the oil platform operators and the radio channels over an IP network via the conference room. The process ends at block 770, where VoIP real-time media is exchanged between the oil platform operators and radio users through the whisper rooms and pseudo-legs of the conference room.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

I claim:

1. A conference server that facilitates communication on oil platforms, comprising:
a conference room operable to manage a conference call between oil platform operators and radio channels, each of said radio channels having a respective group of radio users communicating with each other thereon, said conference room further including whisper rooms, each being communicatively coupled to one of said oil platform operators or said radio channels;
an application program interface communicatively coupled to receive conferencing instructions from one or more of said oil platform operators; and
processing circuitry coupled to said conference room and said application program interface, said processing circuitry operable to create said conference room and said whisper rooms, and further operable to create pseudo-legs between ones of said whisper rooms to enable each of said oil platform operators to speak and listen to desired ones of said radio channels and other ones of said oil platform operators based on said conferencing instructions;
wherein said processing circuitry is further operable to process and exchange Voice over Internet Protocol (VoIP) real-time media streams between said oil platform operators and said radio users through said whisper rooms and said pseudo-legs.

2. The conference server of claim 1, further comprising:
an Internet Protocol (IP) network interface coupled to an IP network over which said VoIP real-time media streams are transmitted and received.

3. The conference server of claim 2, wherein said IP network interface further coupled to a radio network including said radio users and providing said radio channels via at least one radio adapter configured to convert said VoIP real-time media streams to a format associated with said radio network.

4. The conference server of claim 3, wherein said radio users are communicating on said radio channels using two-way radio devices.

5. The conference server of claim 2, wherein said application program interface receives said conferencing instructions from an oil platform server via said IP network interface, said oil platform server being coupled via said IP network to oil platform control clients running on computing devices operated by said oil platform operators, said oil platform server receiving operator instructions initiated by said oil platform operators on said oil platform control clients and generating said conferencing instructions in response thereto.

6. The conference server of claim 5, wherein said conferencing instructions instruct said processing circuitry to set-up or tear down ones of said pseudo-legs, each of said pseudo-legs enabling one-way voice communication between two of said whisper rooms.

7. The conference server of claim 1, further comprising:
a conferencing software module executable by said processing circuitry to create and manage said conference room, said whisper rooms and said pseudo-legs; and
a memory device within which said conference room is created.

8. The conference server of claim 1, wherein said VoIP real-time media streams include voice streams and data.

9. The conference server of claim 8, wherein said data includes text and multi-media that enables data collaboration between said oil platform operators, said data collaboration providing one or more of instant messaging, presentation sharing, desktop sharing and video.

10. A communications system facilitating communication on oil platforms, comprising:
an oil platform server communicatively coupled to receive operator instructions initiated by oil platform operators, said oil platform server operable to generate conferencing instructions based on said operator instructions; and
a conference server coupled to said oil platform server via an Internet Protocol (IP) network to receive said operator instructions, said conference server operable, based on said conferencing instructions, to create a conference room for managing a conference call between said oil platform operators and radio channels, each of said radio channels having a respective group of radio users communicating with each other thereon, said conference room including whisper rooms, each being communicatively coupled to one of said oil platform operators or said radio channels, said conference room further including pseudo-legs between ones of said whisper rooms to enable each of said oil platform operators to speak and listen to desired ones of said radio channels and other ones of said oil platform operators;
wherein said conference server is further operable to process and exchange Voice over Internet Protocol (VoIP) real-time media streams between said oil platform operators and said radio users through said whisper rooms and said pseudo-legs.

11. The communication system of claim 10, further comprising:
radio adapters coupled to a radio network including two-way radio devices operated by said radio users, each of said radio adapters communicating with a group of said radio users on a respective one of said radio channels and each of said radio adapters for converting media between a first format associated with said radio network and a second format associated with said Internet Protocol (IP) network to transmit and receive said VoIP real-time media streams between said two-way radio devices and said conference server.

12. The communication system of claim 11, further comprising:
oil platform control clients running on computing devices operated by said oil platform operators, each of said oil platform clients operable to generate said respective operator instructions based on input from said respective oil platform operators.

13. The communication system of claim 12, wherein each of said oil platform control clients provides a graphical user interface to said respective one of said oil platform operators, said graphical user interface enabling said respective one of said oil platform operators to enter said respective operator instructions.

14. The communication system of claim 13, wherein said operator instructions include selecting one of said radio channels on which to listen or speak.

15. The communication system of claim 13, wherein each of said oil platform control clients includes a softphone for transmitting and receiving said VoIP real-time media streams between said computing devices and said conference server.

16. The communication system of claim 13, wherein said graphical user interface is presented on a touch screen of said computing device.

17. The communication system of claim 13, wherein:
said VoIP real-time media streams include voice streams and data, said data including text and multi-media; and
said oil platform control clients enable data collaboration between said oil platform operators, said data collaboration providing one or more of instant messaging, presentation sharing, desktop sharing and video.

18. The communication system of claim 10, wherein said oil platform server maintains time-dependent matrices including real-valued coefficients describing ones of said oil platform operators currently speaking to ones of said radio channels, ones of said radio channels listened to by ones of said oil platform operators and ones of said oil platform operators heard by other ones of said oil platform operators.

19. The communication system of claim 18, wherein said oil platform server defines said real-valued coefficients within said time-dependent matrices based on said operator instructions and accesses said real-valued coefficients to generate said conferencing instructions to set-up and tear down ones of said pseudo-legs and apply respective gains to each of said pseudo-legs.

20. The communication system of claim 10, further comprising:
a back-up oil platform server coupled to back-up said oil platform server; and
a back-up conference server coupled to back-up said conference server.

21. A method for facilitating communication on oil platforms, comprising:
receiving an establish instruction to establish a conference call between oil platform operators and radio channels, each of said radio channels having a respective group of radio users communicating thereon;
creating a conference room for said conference call;
receiving whisper room instructions to create respective whisper rooms in said conference room for each of said oil platform operators and said radio channels;
receiving conferencing instructions from said oil platform operators to create pseudo-legs between ones of said whisper rooms to enable each of said oil platform operators to speak and listen to desired ones of said radio channels and other ones of said oil platform operators;
establishing a connection between said oil platform operators and said radio channels over an Internet Protocol (IP) network via said conference room; and
exchanging Voice over Internet Protocol (VoIP) real-time media streams between said oil platform operators and said radio users through said whisper rooms and said pseudo-legs.
